(19) United States
(12) Patent Application Publication
(10) Pub. No.: US 2025/0224648 A1
(43) Pub. Date: Jul. 10, 2025

(54) CAPSULE TYPE ELECTROPHORETIC DISPLAY MEDIUM FILM AND MANUFACTURING METHOD THEREOF

(71) Applicant: E Ink Holdings Inc., Hsinchu (TW)

(72) Inventors: Chao Feng Sung, Hsinchu (TW); Chen Chu Tsai, Hsinchu (TW); Ming-Huan Yang, Hsinchu (TW)

(73) Assignee: E Ink Holdings Inc., Hsinchu (TW)

(21) Appl. No.: 19/002,780

(22) Filed: Dec. 27, 2024

(30) Foreign Application Priority Data
Jan. 10, 2024 (TW) 113101016

(51) Int. Cl. G02F 1/16756; G02F 1/167; G02F 1/1676

(52) U.S. Cl. CPC G02F 1/16756; G02F 1/167; G02F 1/1676

(57) ABSTRACT

A capsule type electrophoretic display medium film and a manufacturing method thereof are provided. The capsule type electrophoretic display medium film includes a first stretchable film, a second stretchable film, and a capsule type electrophoretic display medium. The second stretchable film is disposed on the first stretchable film. The capsule type electrophoretic display medium is disposed between the first stretchable film and the second stretchable film and includes multiple capsules. At least one capsule among the capsules presents an elliptical, polygonal, or irregular shape when the capsule type electrophoretic display medium film is in a non-stretched state.

### CROSS-REFERENCE TO RELATED APPLICATION

This application claims the priority benefit of Taiwan application serial no. 113101016, filed on Jan. 10, 2024. The entirety of the above-mentioned patent application is hereby incorporated by reference herein and made a part of this specification.

### BACKGROUND

### Technical Field

The disclosure relates to an electronic product and a manufacturing method thereof, and more particularly, to a capsule type electrophoretic display medium film and a manufacturing method thereof.

### Description of Related Art

An electrophoretic display has advantages of light weight and thin thickness. Using a flexible substrate structure, the electrophoretic display may further have advantages of being stretchable and unbreakable. However, stretchability of the electrophoretic display is limited by stretchability of a display medium. The stretchability of the display medium has an upper limit of deformation due to material or structural limitations, resulting in limitations in product applications and affects a using experience of a consumer.

### SUMMARY

The disclosure provides a capsule type electrophoretic display medium film and a manufacturing method thereof, which helps to improve stretchability.

A capsule type electrophoretic display medium film in the disclosure includes a first stretchable film, a second stretchable film, and a capsule type electrophoretic display medium. The second stretchable film is disposed on the first stretchable film. The capsule type electrophoretic display medium is disposed between the first stretchable film and the second stretchable film and includes multiple capsules. At least one capsule among the capsules presents an elliptical, polygonal, or irregular shape when the capsule type electrophoretic display medium film is in a non-stretched state.

In an embodiment of the disclosure, an aspect ratio of the at least one capsule falls within a range of 1.3 to 1.7.

In an embodiment of the disclosure, materials of the first stretchable film and the second stretchable film include thermoplastic elastomers.

In an embodiment of the disclosure, Young's modulus of a stretch film for the first stretchable film and the second stretchable film is 1 to 1000 Mpa.

In an embodiment of the disclosure, the capsule type electrophoretic display medium film further includes a first stretchable electrode and a second stretchable electrode. The first stretchable electrode is disposed between the first stretchable film and the second stretchable film. The second stretchable electrode is disposed between the first stretchable electrode and the second stretchable film.

In an embodiment of the disclosure, materials of the first stretchable electrode and the

second stretchable electrode include polymer conductive materials, carbon nanotubes, conductive silver adhesives, or conductive carbon pastes.

In an embodiment of the disclosure, the capsule type electrophoretic display medium film further includes a third stretchable film and a package adhesive. The first stretchable film, the first stretchable electrode, the capsule type electrophoretic display medium, the second stretchable electrode, and the second stretchable film are stacked on the third stretchable film in sequence. The package adhesive is disposed between the third stretchable film and the second stretchable electrode and surrounds the first stretchable film, the first stretchable electrode, and the capsule type electrophoretic display medium.

A manufacturing method of a capsule type electrophoretic display medium film includes the following. A first stretchable film is stretched. When the first stretchable film is in a stretched state, a capsule type electrophoretic display medium is attached to the first stretchable film. A second stretchable film is stretched. When the first stretchable film and the second stretchable film are both in the stretched state, the second stretchable film is attached to the capsule type electrophoretic display medium. Tensile stress of the first stretchable film and the second stretchable film is released to pre-shrink the capsule type electrophoretic display medium.

In an embodiment of the disclosure, stretching amounts of the first stretchable film and the second stretchable film are greater than 100% and less than or equal to 1000%.

A manufacturing method of a capsule type electrophoretic display medium film in the disclosure includes the following. A first stretchable electrode is formed on a first stretchable film, and the first stretchable film is stretched. When the first stretchable film is in a stretched state, a capsule type electrophoretic display medium is attached to the first stretchable electrode. Tensile stress of the first stretchable film is released to pre-shrink the capsule type electrophoretic display medium. A second stretchable electrode is formed on a second stretchable film. The second stretchable electrode formed on the second stretchable film is attached to the capsule type electrophoretic display medium.

In an embodiment of the disclosure, the manufacturing method of the capsule type electrophoretic display medium film further includes the following. After the second stretchable electrode is formed on the second stretchable film, and before the second stretchable electrode is attached to the capsule type electrophoretic display medium, the second stretchable film is stretched. When the second stretchable electrode is attached to the capsule type electrophoretic display medium, the first stretchable film and the second stretchable film are both in the stretched state. Pre-shrinking the capsule type electrophoretic display medium further includes releasing tensile stress of the second stretchable film.

In an embodiment of the disclosure, stretching amounts of the first stretchable film and the second stretchable film are greater than 100% and less than or equal to 1000%.

In an embodiment of the disclosure, pre-shrinking the capsule type electrophoretic display medium is that before the second stretchable electrode is attached to the capsule type electrophoretic display medium, and when the second stretchable electrode is attached to the capsule type electrophoretic display medium, the second stretchable film is in a non-stretched state.

In an embodiment of the disclosure, the manufacturing method of the capsule type electrophoretic display medium film further includes the following. A third stretchable film is attached to the first stretchable film. A package adhesive surrounding the first stretchable film, the first stretchable electrode, and the capsule type electrophoretic display medium is formed between the third stretchable film and the second stretchable electrode.

In order for the aforementioned features and advantages of the disclosure to be more comprehensible, embodiments accompanied with drawings are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A to 1D are schematic partial cross-sectional views of a manufacturing process of a capsule type electrophoretic display medium film according to an embodiment of the disclosure.

FIG. 2 is a schematic partial enlarged top view of a capsule type electrophoretic display medium in FIG. 1.

FIGS. 3A to 3E are schematic partial cross-sectional views of a manufacturing process of a capsule type electrophoretic display medium film according to another embodiment of the disclosure.

FIGS. 4A to 4E are schematic partial cross-sectional views of a manufacturing process of a capsule type electrophoretic display medium film according to still another embodiment of the disclosure.

### DETAILED DESCRIPTION OF DISCLOSED EMBODIMENTS

Directional terms used herein, such as “upper,” “lower,” “front,” “rear,” “left” and “right,” merely refer to directions in the accompanying drawings. Therefore, the directional terms are used to illustrate rather than limit the disclosure.

In the accompanying drawings, each drawing depicts general features of methods, structures, or materials used in specific embodiments. However, these drawings should not be construed as defining or limiting the scope or nature covered by these embodiments. For example, for clarity, the relative size, thickness and position of each layer, region or structure may be reduced or enlarged.

In the f accompanying drawings, the same or similar elements will be denoted by the same or similar reference numerals, and repeated description thereof will be omitted in the specification. In addition, the features in different embodiments can be combined without conflict, and all simple equivalent changes and modifications made in accordance with the present specification or claims still fall within the scope of the disclosure.

The terms “first” and “second” mentioned in the present specification or claims are only used to name different elements or distinguish different embodiments or ranges, and are not used to limit an upper or lower limit of the number of elements, nor to limit the manufacturing order or disposition order of the elements. In addition, the disposition of one element/film layer on (or above) another element/film layer can encompass the element/film layer being directly disposed on (or above) the other element/film layer, with the two elements/film layers being in direct contact with each other, and the element/film layer being indirectly disposed on (or above) the other element/film layer, with one or more elements/film layers located between the two elements/film layers.

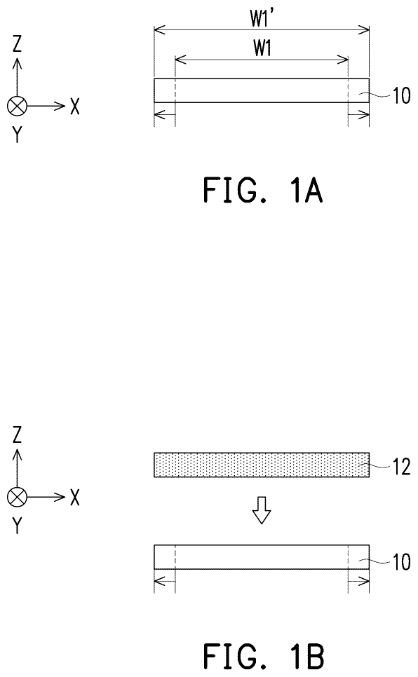

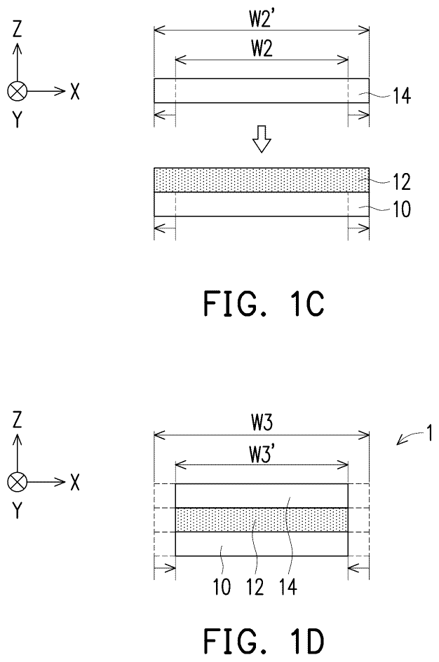

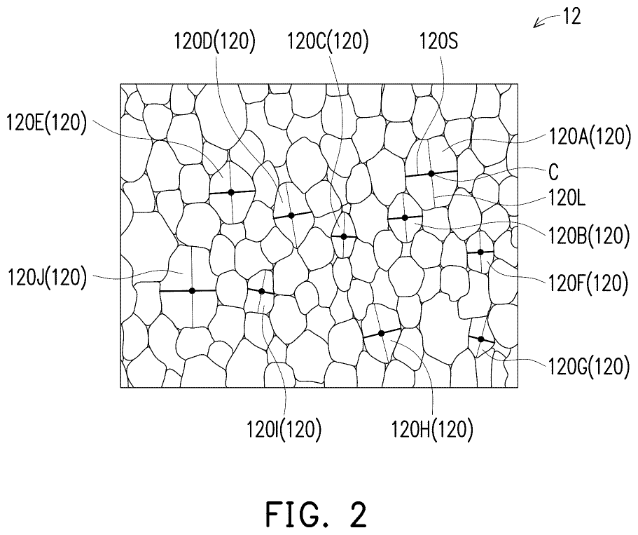

FIGS. 1A to 1D are schematic partial cross-sectional views of a manufacturing process of a capsule type electrophoretic display medium film according to an embodiment of the disclosure. FIG. 2 is a schematic partial enlarged top view of a capsule type electrophoretic display medium in FIG. 1.

Referring to FIG. 1A first, a manufacturing method of the capsule type electrophoretic display medium film may include the following. A first stretchable film 10 is stretched. Dashed lines in FIG. 1A represents the unstretched first stretchable film 10, and solid lines in FIG. 1A represents the stretched first stretchable film 10.

In some embodiments, the first stretchable film 10 may be a stretchable release film. For example, a material of the first stretchable film 10 may include thermoplastic elastomers (TPE). The thermoplastic elastomers may include thermoplastic rubber (TPR), thermoplastic vulcanizate (TPV), thermoplastic polyurethane (TPU), or thermoplastic polyether ester elastomer (TPEE), but the disclosure is not limited thereto.

In some embodiments, a step of stretching the first stretchable film 10 maybe to stretch the first stretchable film 10 from a width W1 to a width W1′. A stretching amount of the first stretchable film 10 is greater than 100% and less than or equal to 1000%, and a preferred range is that the stretching amount is greater than 100% and less than or equal to 800%. The stretching amount is defined as a width variation divided by an original width multiplied by a percentage, that is, (W1′−W1)/W1*100%.

FIG. 1A schematically illustrates that the first stretchable film 10 is stretched in a direction parallel to a direction X (e.g., the direction X and an opposite direction thereof), but the disclosure is not limited thereto. According to different requirements, the first stretchable film 10 may be stretched in other directions (e.g., a direction Y and an opposite direction thereof). The direction X and the direction Y intersect each other, and are both parallel to a surface of the first stretchable film 10 and perpendicular to a thickness direction (e.g., a direction Z) of the first stretchable film 10. In some embodiments, the direction X and the direction Y are perpendicular to each other.

Referring to FIGS. 1B and 1C, the manufacturing method of the capsule type electrophoretic display medium film may further include the following. A capsule type electrophoretic display medium 12 is attached to the first stretchable film 10 when the first stretchable film 10 is in a stretched state. In other words, the capsule type electrophoretic display medium 12 may be attached to the first stretchable film 10 through an adhesive layer (not shown) without releasing tensile stress applied to the first stretchable film 10.

In some embodiments, as shown in FIG. 1B, in a non-stretched state, the capsule type electrophoretic display medium 12 is attached to the first stretchable film 10 in the stretched state. In this article, a certain film layer being in the non-stretched state means that a stretching amount of the film layer is zero or close to zero. For example, the film layer may present an unfolding state without substantially changing a dimension (e.g., a width) of the film layer.

In some embodiments, as shown in FIG. 2, the capsule type electrophoretic display medium 12 may include multiple capsules 120. The capsules 120 are distributed on a plane formed by the direction X and the direction Y. Although not shown, each of the capsules 120 may be formed with a transparent liquid and particles of multiple colors (e.g., black and white and/or other colors) located in the transparent liquid. The particles of different colors have different electrical properties (e.g., positive and negative electricity). Through control of an external voltage or electric field (not shown), a distribution state of the particles of different colors may be changed, thereby controlling the color displayed by the capsule type electrophoretic display medium 12.

Referring to FIG. 1C, the manufacturing method of the capsule type electrophoretic display medium film may further include the following. A second stretchable film 14 is stretched. Dashed lines in FIG. 1C represents the unstretched second stretchable film 14, and solid lines in FIG. 1C represents the stretched second stretchable film 14.

In some embodiments, the second stretchable film 14 may be a stretchable release film. For example, a material of second stretchable film 14 may include thermoplastic elastomers. The thermoplastic elastomers may include thermoplastic rubber, thermoplastic vulcanizate, thermoplastic polyurethane, or thermoplastic polyether ester elastomer, but the disclosure is not limited thereto.

In some embodiments, a step of stretching the second stretchable film 14 may be to stretch the second stretchable film 14 from a width W2 to a width W2′. A stretching amount of the second stretchable film 14 is greater than 100% and less than or equal to 1000%, and a preferred range is that the stretching amount is greater than 100% and less than or equal to 800%. The stretching amount is defined as the width variation divided by the original width multiplied by the percentage, that is, (W2′−W2)/W2*100%.

FIG. 1C schematically illustrates that the second stretchable film 14 is stretched in the direction parallel to the direction X (e.g., the direction X and the opposite direction thereof), but the disclosure is not limited thereto. According to different requirements, the second stretchable film 14 may be stretched in other directions (e.g., the direction Y and the opposite direction thereof).

Continuing to refer to FIG. 1C, the manufacturing method of the capsule type electrophoretic display medium film may further include the following. When the first stretchable film 10 and the second stretchable film 14 are both in the stretched state, the second stretchable film 14 is attached to the capsule type electrophoretic display medium 12. In other words, without releasing the tensile stress applied to the first stretchable film 10 and the second stretchable film 14, the second stretchable film 14 may be attached to the capsule type electrophoretic display medium 12 through the adhesive layer (not shown).

Referring to FIG. 1D, the manufacturing method of the capsule type electrophoretic display medium film may further include the following. The tensile stress of the first stretchable film 10 and the second stretchable film 14 is released to pre-shrink the capsule type electrophoretic display medium 12. Dashed lines in FIG. 1D represents the first stretchable film 10, the capsule type electrophoretic display medium 12, and the second stretchable film 14 before the tensile stress is released, and solid lines in FIG. 1D represents the first stretchable film 10, the capsule type electrophoretic display medium 12, and the second stretchable film 14 after the tensile stress is released.

In the pre-shrinking step, the capsule type electrophoretic display medium 12 shrinks from a width W3 to a width W3′, for example. A shrinkage amount of the capsule type electrophoretic display medium 12 is greater than 100% and less than or equal to 1000%, and a preferred range is greater than 100% and less than or equal to 800%. The shrinkage amount is defined as an absolute value of the width variation divided by the original width multiplied by the percentage, that is, |(W3′−W3)|/W3*100%.

By pre-shrinking the capsule type electrophoretic display medium 12, the capsules in the capsule type electrophoretic display medium 12 may be arranged more closely, so that the capsule type electrophoretic display medium 12 has higher stretchability. According to an experimental example, the capsules in the non-preshrunk capsule type electrophoretic display medium began to rupture when the stretching amount was about 31% to 35%, while the capsules in the pre-shrunk capsule type electrophoretic display medium began to rupture when the stretching amount was about 70%. As a result, it is proved that the pre-shrunk capsule type electrophoretic display medium has higher stretchability.

After completing the pre-shrinking step, manufacturing of a capsule type electrophoretic display medium film 1 is initially completed. Referring to FIGS. 1D and 2, the capsule type electrophoretic display medium film 1 may include the first stretchable film 10, the second stretchable film 14, and the capsule type electrophoretic display medium 12. The second stretchable film 14 is disposed on the first stretchable film 10. The capsule type electrophoretic display medium 12 is disposed between the first stretchable film 10 and the second stretchable film 14 and includes the capsules 120. At least one capsule 120 (e.g., a capsule 120A, a capsule 120B, a capsule 120C, a capsule 120D, a capsule 120E, a capsule 120F, a capsule 120G, a capsule 120H, a capsule 120I, or a capsule 120J) among the capsules 120 presents an elliptical, polygonal, or irregular shape when the capsule type electrophoretic display medium film 1 is in the non-stretched state (that is, the stretching amount is zero or close to zero).

Specifically, after the pre-shrinking step, the capsules 120 in the capsule type electrophoretic display medium 12 are arranged more closely under compressive stress, and the at least one capsule 120 is compressed to change from a quasi-circular shape to a quasi-elliptical, polygonal, or irregular shape. In this article, the capsule 120 presenting the elliptical shape generally means that the capsule 120 has a long axis 120L and a short axis 120S perpendicular to each other. Viewed from a top view, the short axis 120S passes through a center C of the capsule 120 and connects two closest opposite ends of the capsule 120, and the long axis 120L passes through the center C of the capsule 120 and is perpendicular to the short axis 120S. The long axis 120L is longer than the short axis 120S. In some embodiments, in about 20% or more of the capsules in the capsule type electrophoretic display medium 12, a ratio (an aspect ratio) of the long axis 120L to the short axis 120S is 1.3 or more, that is, 120L/120S≥1.3. In some embodiments, the aspect ratio of the at least one capsule 120 falls within a range of 1.3 to 1.7.As shown in FIG. 2, aspect ratios of the capsule 120A, the capsule 120B, the capsule 120C, the capsule 120D, the capsule 120E, the capsule 120F, the capsule 120G, the capsule 120H, the capsule 120I, and the capsule 120J are respectively 1.52, 1.41, 1.68, 1.55, 1.27, 1.59, 1.64, 1.47, 1.52, and 1.46. In FIG. 2, the aspect ratios of 20% or more of the capsules will be in the range of 1.3 to 1.7.

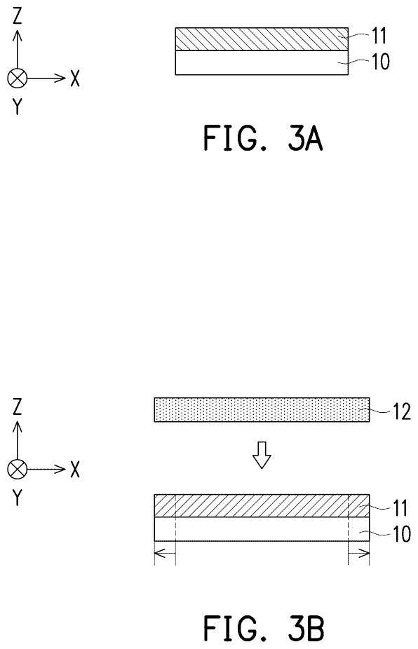

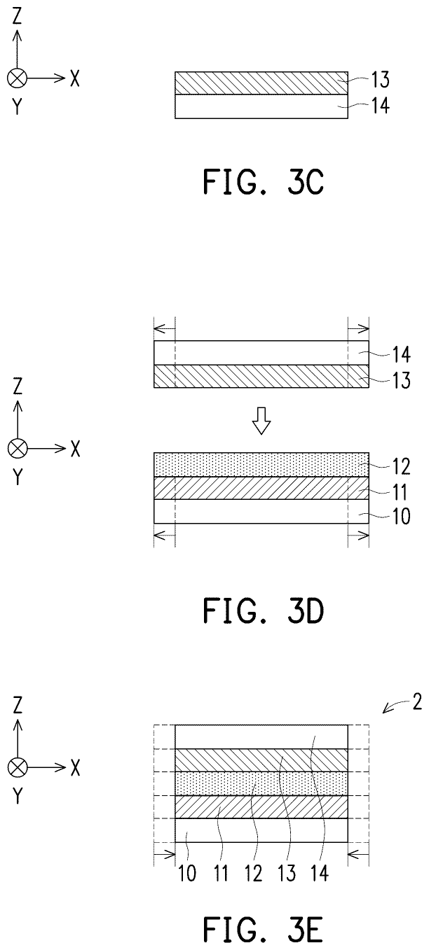

FIGS. 3A to 3E are schematic partial cross-sectional views of a manufacturing process of a capsule type electrophoretic display medium film according to another embodiment of the disclosure. Referring to FIGS. 3A and 3B first, the manufacturing method of the capsule type electrophoretic display medium film may include the following. A first stretchable electrode 11 is formed on the first stretchable film 10 (see FIG. 3A), and the first stretchable film 10 is stretched (see FIG. 3B).

The aforementioned embodiment may be referred for the relevant content of the first

stretchable film 10. Therefore, the same details will not be repeated in the following. A material of the first stretchable electrode 11 may include polymer conductive materials, carbon nanotubes, conductive silver adhesives, conductive carbon pastes, or other conductive materials with high stretch strength, and the first stretchable electrode 11 may be formed on the first stretchable film 10 by coating or other feasible methods, for example. When the first stretchable film 10 is stretched, the first stretchable electrode 11 may be stretched along with the first stretchable film 10, and a stretching amount of the first stretchable electrode 11 may be the same as or similar to the stretching amount of the first stretchable film 10, and is not limited thereto.

Continuing to refer to FIG. 3B, the manufacturing method of the capsule type electrophoretic display medium film may further include the following. The capsule type electrophoretic display medium 12 is attached to the first stretchable electrode 11 when the first stretchable film 10 is in the stretched state. In other words, the capsule type electrophoretic display medium 12 may be attached to the first stretchable electrode 11 through the adhesive layer (not shown) without releasing the tensile stress applied to the first stretchable film 10. The aforementioned embodiment may be referred for the relevant content of the capsule type electrophoretic display medium 12. Therefore, the same details will not be repeated in the following.

Referring to FIG. 3C, the manufacturing method of the capsule type electrophoretic display medium film may further include the following. A second stretchable electrode 13 is formed on the second stretchable film 14. A material of the second stretchable electrode 13 may include polymer conductive materials, carbon nanotubes, conductive silver adhesives, conductive carbon pastes, or other conductive materials with high stretch strength, and the second stretchable electrode 13 may be formed on the second stretchable film 14 by coating or other feasible methods, for example.

Referring to FIG. 3D, the manufacturing method of the capsule type electrophoretic display medium film may further include the following. The second stretchable electrode 13 formed on the second stretchable film 14 is attached to the capsule type electrophoretic display medium 12. In some embodiments, as shown in FIG. 3D, the manufacturing method of the capsule type electrophoretic display medium film may further include the following. After the second stretchable electrode 13 is formed on the second stretchable film 14, and before the second stretchable electrode 13 is attached to the capsule type electrophoretic display medium 12, the second stretchable film 14 is stretched. When the second stretchable film 14 is stretched, the second stretchable electrode 13 may be stretched along with the second stretchable film 14, and a stretching amount of the second stretchable electrode 13 may be the same as or similar to the stretching amount of the second stretchable film 14, and is not limited thereto.

When the second stretchable electrode 13 is attached to the capsule type electrophoretic display medium 12, both the first stretchable film 10 and the second stretchable film 14 are in the stretched state. At the same time, both the first stretchable electrode 11 disposed on the first stretchable film 10 and the second stretchable electrode 13 disposed on the second stretchable film 14 are also in the stretched state. In addition, the step of attaching the second stretchable electrode 13 to the capsule type electrophoretic display medium 12 may include the following. The second stretchable film 14 is flipped such that the second stretchable electrode 13 faces the capsule type electrophoretic display medium 12, and then the second stretchable electrode 13 is attached to the capsule type electrophoretic display medium 12 through the adhesive layer (not shown).

Referring to FIG. 3E, the manufacturing method of the capsule type electrophoretic display medium film may further include the following. The tensile stress of the first stretchable film 10 is released to pre-shrink the capsule type electrophoretic display medium 12. In some embodiments, as shown in FIG. 3E, pre-shrinking the capsule type electrophoretic display medium 12 may further include releasing the tensile stress of the second stretchable film 14. In other words, after the second stretchable electrode 13 is attached to the capsule type electrophoretic display medium 12, the tensile stress of the first stretchable film 10 and the second stretchable film 14 may be released, so that the capsule type electrophoretic display medium 12 is pre-shrunk. Dashed lines in FIG. 3E represent the first stretchable film 10, the first stretchable electrode 11, the capsule type electrophoretic display medium 12, the second stretchable electrode 13, and the second stretchable film 14 before the tensile stress is released, and solid lines in FIG. 3E represent the first stretchable film 10, the first stretchable electrode 11, the capsule type electrophoretic display medium 12, the second stretchable electrode 13, and the second stretchable film 14 after the tensile stress is released.

In the pre-shrinking step, a width (not marked) of the capsule type electrophoretic display medium 12 becomes smaller, and a shrinking amount of the capsule type electrophoretic display medium 12 may be greater than 0% and less than or equal to 100%. By pre-shrinking the capsule type electrophoretic display medium 12, the capsules in the capsule type electrophoretic display medium 12 may be arranged more closely, so that the capsule type electrophoretic display medium 12 has higher stretchability.

After completing the pre-shrinking step, manufacturing of a capsule type electrophoretic display medium film 2 is initially completed. Referring to FIGS. 3E and 2, the capsule type electrophoretic display medium film 2 may include the first stretchable film 10, the second stretchable film 14, the first stretchable electrode 11, the second stretchable electrode 13, and the capsule type electrophoretic display medium 12. The second stretchable film 14 is disposed on the first stretchable film 10. The first stretchable electrode 11 is disposed between the first stretchable film 10 and the second stretchable film 14. The second stretchable electrode 13 is disposed between the first stretchable electrode 11 and the second stretchable film 14. The capsule type electrophoretic display medium 12 is disposed between the first stretchable electrode 11 and the second stretchable electrode 13 and includes the capsules 120. At least one capsule (e.g., the capsule 120A, the capsule 120B, the capsule 120C, the capsule 120D, the capsule 120E, the capsule 120F, the capsule 120G, the capsule 120H, the capsule 120I, or the capsule 120J) among the capsules 120 presents the elliptical, polygonal, or irregular shape when the capsule type electrophoretic display medium film 2 is in the non-stretched state. The aforementioned embodiment may be referred for the relevant content of the capsule 120. Therefore, the same details will not be repeated in the following.

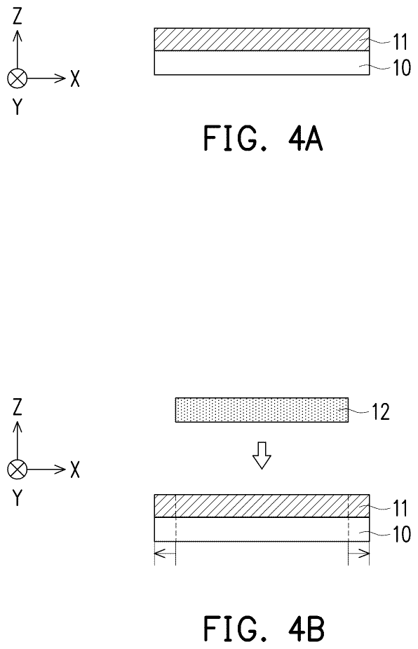

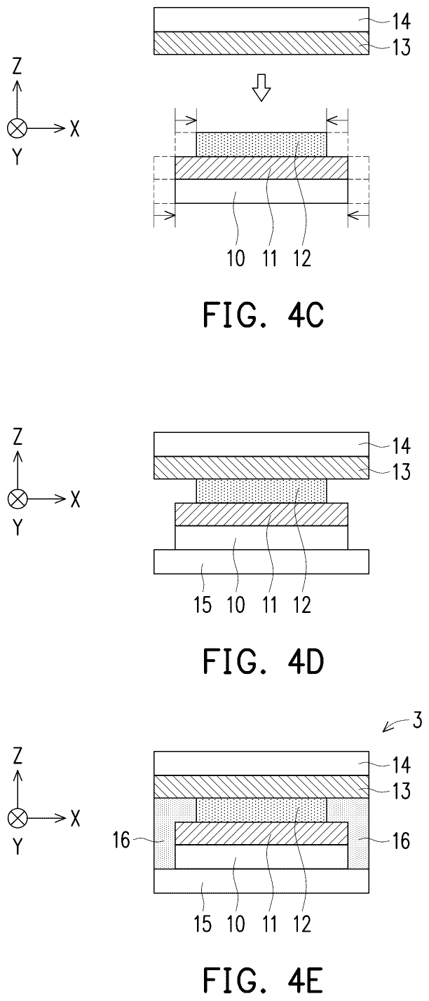

FIGS. 4A to 4E are schematic partial cross-sectional views of a manufacturing process of a capsule type electrophoretic display medium film according to still another embodiment of the disclosure. Referring to FIGS. 4A and 4B first, the manufacturing method of the capsule type electrophoretic display medium film may include the following. The first stretchable electrode 11 is formed on the first stretchable film 10 (see FIG. 4A), and the first stretchable film 10 is stretched (see FIG. 4B). The aforementioned embodiment (corresponding to the descriptions of FIGS. 3A and 3B) may be referred for the relevant content of the above steps. Therefore, the same details will not be repeated in the following.

Continuing to refer to FIG. 4B, the manufacturing method of the capsule type electrophoretic display medium film may further include the following. The capsule type electrophoretic display medium 12 is attached to the first stretchable electrode 11 when the first stretchable film 10 is in the stretched state. The aforementioned embodiment (corresponding to the description of FIG. 3B) may be referred for the relevant content of the step. Therefore, the same details will not be repeated in the following.

Referring to FIG. 4C, the manufacturing method of the capsule type electrophoretic display medium film may further include the following. The second stretchable electrode 13 is formed on the second stretchable film 14. The aforementioned embodiment (corresponding to the description of FIG. 3C) may be referred for the relevant content of the material of the second stretchable electrode 13 and the formation thereof on the second stretchable film 14. Therefore, the same details will not be repeated in the following. In some embodiments, the second stretchable film 14 may be a substrate with water-blocking properties. For example, a material of the second stretchable film 14 may include a water-blocking material. The water-blocking material may include polyethylene terephthalate (PET) or polychlorotrifluoroethylene (PCTFE), but the disclosure is not limited thereto.

Referring to FIGS. 4C and 4D, the manufacturing method of the capsule type electrophoretic display medium film may further include the following. The tensile stress of the first stretchable film 10 is released to pre-shrink the capsule type electrophoretic display medium 12 (see FIG. 4C), and the second stretchable electrode 13 formed on the second stretchable film 14 is attached to the capsule type electrophoretic display medium 12 (see FIG. 4D). Dashed lines in FIG. 4C represents the first stretchable film 10, the first stretchable electrode 11, and the capsule type electrophoretic display medium 12 before the tensile stress is released, and solid lines in FIG. 4C represent the first stretchable film 10, the first stretchable electrode 11, and the capsule type electrophoretic display medium 12 after the tensile stress is released.

Different from FIGS. 3D and 3E, in this embodiment, pre-shrinking the capsule type electrophoretic display medium 12 is that before the second stretchable electrode 13 is attached to the capsule type electrophoretic display medium 12, and when the second stretchable electrode 13 is attached to the capsule type electrophoretic display medium 12, the second stretchable film 14 is in the non-stretched state (the stretching amount is zero or close to zero).

Specifically, in this embodiment, the tensile stress applied to the first stretchable film 10 is released before the capsule type electrophoretic display medium 12 is attached to the second stretchable electrode 13, and the second stretchable electrode 13 and the second stretchable electrode 13 and the second stretchable film 14 are both in the non-stretched state (the stretching amount is zero or close to zero) during the manufacturing process of the capsule type electrophoretic display medium film.

Referring to FIG. 4D, the manufacturing method of the capsule type electrophoretic display medium film may further include the following. A third stretchable film 15 is attached to the first stretchable film 10. In some embodiments, the third stretchable film 15 may be a substrate with water-blocking properties. For example, a material of the third stretchable film 15 may include a water-blocking material. The water-blocking material may include polyethylene terephthalate or polychlorotrifluoroethylene, but the disclosure is not limited thereto. In addition, the third stretchable film 15 may be attached to the first stretchable film 10 through the adhesive layer (not shown).

Referring to FIG. 4E, the manufacturing method of the capsule type electrophoretic display medium film may further include the following. A package adhesive 16 surrounding the first stretchable film 10, the first stretchable electrode 11, and the capsule type electrophoretic display medium 12 is formed between the third stretchable film 15 and the second stretchable electrode 13. In some embodiments, a material of the package adhesive 16 may include thermoplastic, thermosetting, ultraviolet curing, or cold curing polymer hardening adhesive, but the disclosure is not limited thereto.

After the package adhesive glue 16 is formed, manufacturing of a capsule type electrophoretic display medium film 3 is initially completed. Referring to FIG. 4E, a main difference between the capsule type electrophoretic display medium film 3 and the capsule type electrophoretic display medium film 2 in FIG. 3E is described as follows. In the capsule type electrophoretic display medium film 3, the second stretchable film 14 is a substrate with water-blocking properties (that is, the material of the second stretchable film 14 includes a water-blocking material). In addition, the capsule type electrophoretic display medium film 3 further includes the third stretchable film 15 and the package adhesive 16. The first stretchable film 10, the first stretchable electrode 11, the capsule type electrophoretic display medium 12, the second stretchable electrode 13, and the second stretchable film 14 are stacked on the third stretchable film 15 in sequence, and the package adhesive 16 is disposed between the third stretchable film 15 and the second stretchable electrode 13, and surrounds the first stretchable film 10, the first stretchable electrode 11, and the capsule type electrophoretic display medium 12.

In the disclosure, Young's modulus of a stretch film for the first stretchable film 10, the second stretchable film 14, or the third stretchable film 15 may be 1 to 1000 Mpa, and a preferred range is 1 to 100 Mpa.

Based on the above, in the embodiment of the disclosure, by pre-shrinking the capsule type electrophoretic display medium, the capsules in the capsule type electrophoretic display medium may be arranged more closely, so that the capsule type electrophoretic display medium has higher stretchability.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A capsule type electrophoretic display medium film, comprising:
a first stretchable film;
a second stretchable film disposed on the first stretchable film; and
a capsule type electrophoretic display medium disposed between the first stretchable film and the second stretchable film and comprises a plurality of capsules, wherein at least one capsule among the capsules presents an elliptical, polygonal, or irregular shape when the capsule type electrophoretic display medium film is in a non-stretched state.

2. The capsule type electrophoretic display medium film according to claim 1, wherein an aspect ratio of the at least one capsule falls within a range of 1.3 to 1.7.

3. The capsule type electrophoretic display medium film according to claim 1, wherein materials of the first stretchable film and the second stretchable film comprise thermoplastic elastomers.

4. The capsule type electrophoretic display medium film according to claim 1, wherein Young's modulus of a stretch film for the first stretchable film and the second stretchable film is 1 to 1000 Mpa.

5. The capsule type electrophoretic display medium film according to claim 1, further comprising:
a first stretchable electrode disposed between the first stretchable film and the second stretchable film; and
a second stretchable electrode disposed between the first stretchable electrode and the second stretchable film.

6. The capsule type electrophoretic display medium film according to claim 5, wherein materials of the first stretchable electrode and the second stretchable electrode comprise polymer conductive materials, carbon nanotubes, conductive silver adhesives, or conductive carbon pastes.

7. The capsule type electrophoretic display medium film according to claim 5, further comprising:
a third stretchable film, wherein the first stretchable film, the first stretchable electrode, the capsule type electrophoretic display medium, the second stretchable electrode, and the second stretchable film are stacked on the third stretchable film in sequence; and
a package adhesive disposed between the third stretchable film and the second stretchable electrode and surrounding the first stretchable film, the first stretchable electrode, and the capsule type electrophoretic display medium.

8. A manufacturing method of a capsule type electrophoretic display medium film, comprising:
stretching a first stretchable film;
when the first stretchable film is in a stretched state, attaching a capsule type electrophoretic display medium to the first stretchable film;
stretching a second stretchable film;
when the first stretchable film and the second stretchable film are both in the stretched state, attaching the second stretchable film to the capsule type electrophoretic display medium; and
releasing tensile stress of the first stretchable film and the second stretchable film to pre-shrink the capsule type electrophoretic display medium.

9. The manufacturing method of the capsule type electrophoretic display medium film according to claim 8, wherein stretching amounts of the first stretchable film and the second stretchable film are greater than 100% and less than or equal to 1000%.

10. A manufacturing method of a capsule type electrophoretic display medium film, comprising:
forming a first stretchable electrode on a first stretchable film and stretching the first stretchable film;
when the first stretchable film is in a stretched state, attaching a capsule type electrophoretic display medium to the first stretchable electrode;
releasing tensile stress of the first stretchable film to pre-shrink the capsule type electrophoretic display medium;
forming a second stretchable electrode on a second stretchable film; and
attaching the second stretchable electrode formed on the second stretchable film to the capsule type electrophoretic display medium.

11. The manufacturing method of the capsule type electrophoretic display medium film according to claim 10, further comprising:
after forming the second stretchable electrode on the second stretchable film and before attaching the second stretchable electrode to the capsule type electrophoretic display medium, stretching the second stretchable film,
wherein when the second stretchable electrode is attached to the capsule type electrophoretic display medium, the first stretchable film and the second stretchable film are both in the stretched state, and
pre-shrinking the capsule type electrophoretic display medium further comprises releasing tensile stress of the second stretchable film.

12. The manufacturing method of the capsule type electrophoretic display medium film according to claim 11, wherein stretching amounts of the first stretchable film and the second stretchable film are greater than 100% and less than or equal to 1000%.

13. The manufacturing method of the capsule type electrophoretic display medium film according to claim 11, wherein pre-shrinking the capsule type electrophoretic display medium is that before the second stretchable electrode is attached to the capsule type electrophoretic display medium, and when the second stretchable electrode is attached to the capsule type electrophoretic display medium, the second stretchable film is in a non-stretched state.

14. The manufacturing method of the capsule type electrophoretic display medium film according to claim 13, further comprising:
attaching a third stretchable film to the first stretchable film; and
forming a package adhesive surrounding the first stretchable film, the first stretchable electrode, and the capsule type electrophoretic display medium between the third stretchable film and the second stretchable electrode.
